(19) United States
(12) Patent Application Publication
(10) Pub. No.: US 2012/0322454 A1
(43) Pub. Date: Dec. 20, 2012

(54) RESOURCE MANAGEMENT FRAMEWORK FOR DISTRIBUTED OFDMA FEMTOCELL NETWORKS

(75) Inventors: Karthikeyan Sundaresan, Howell, NJ (US); Jongwon Yoon, Seoul (KR); Mustafa Y. Arslan, Riverside, CA (US)

(73) Assignee: NEC Laboratories America, Inc., Princeton, NJ (US)

(21) Appl. No.: 13/495,770

(22) Filed: Jun. 13, 2012

Related U.S. Application Data
(60) Provisional application No. 61/497,775, filed on Jun. 16, 2011.

(51) Int. Cl. H04W 72/04

(52) U.S. Cl. 455/450

(57) ABSTRACT

Systems and methods for resource management in distributed femtocell networks include categorizing a clients into a first category that includes interference-insensitive clients and a second category that includes interference-sensitive clients and sub-categorizing the clients in the second category into a low-sensitivity sub-category and a high-sensitivity sub-category. A desired local reuse zone is determined based on a number of interference-insensitive clients and a common reuse zone size is determined based on transmissions from neighboring base stations. Positions for a local reuse zone, transition zone, and isolation zone within a frame are allocated based on the desired local reuse zone and the common reuse zone size. Probing is used on a coarse time scale to determine whether network conditions have changed and, if network conditions have changed, a fine time scale is used for probing to adjust zone sizes according to the changed network conditions.

### RELATED APPLICATION INFORMATION

This application claims priority to provisional application Ser. No. 61/497,775, filed on Jun. 16, 2011, incorporated herein by reference.

### BACKGROUND

1. Technical Field

The present invention relates to orthogonal frequency division multiple access networks and, more particularly, to resource management in such networks.

2. Description of the Related Art

As demand for high data rates on mobile devices increases, so too does the demand for increased spectral efficiencies in transmissions. Small cells for orthogonal frequency division multiple access (OFDMA) networks, called “femtocells” in some cases, are designed to provide improved coverage and improved data capacity at a much lower cost and transmission power than their macrocell counterparts. Femtocells are frequently installed indoors and use the same spectrum to synchronously access a channel, connecting to a core network through an existing broadband connection, such as cable or DSL.

Femtocells present substantial advantages to mobile broadband customers and service providers. Customer equipment, such as a 4G capable mobile phone or laptop, can save energy on its uplink when connecting to a femtocell, because the device will not have to transmit to a distant base station. The downlink throughput is also increased, due to shorter ranges. Furthermore, with femtocells, users can continuously experience “5-bar” cellular signal indoors, despite of poor macrocell coverage.

Femtocells are deployed by end users in an unplanned fashion, without direct intervention of the service provider. Thus, interference will inevitably be a performance limiting factor as femtocells become more popular, just as with residential WiFi networks today. There are two potential sources of interference: (i) interference from/to the macrocell and (ii) interference between femtocells. In practical residential settings, where the installed femtocell base stations (BSs) cannot be expected to cooperate, centralized solutions cannot be applied.

Furthermore, WiFi interference management techniques cannot be extended to OFDMA networks for several reasons. WiFi is an asynchronous access technology, whereas OFDMA is synchronous. In OFDMA, a given spectrum is allocated to femtocells in a granularity that allows flexible bandwidth allocation—each femtocell operates on mutually orthogonal subsets of frame resources to avoid interference. Furthermore, WiFi clients can easily detect the availability of resources, whereas femtocells and their clients cannot sense spectral usage. In addition, WiFi does not multiplex transmissions in a given downlink frame. Hence, there is no effective, decentralized resource management tool for OFDMA networks.

### SUMMARY

A method for scheduling includes categorizing a plurality of clients into a first category that includes interference-insensitive clients and a second category that includes interference-sensitive clients; sub-categorizing the clients in the second category into a low-sensitivity sub-category and a high-sensitivity sub-category; and transmitting frames to the plurality of clients that include a local reuse zone comprising transmissions to the first category, a transition zone comprising transmissions to the low-sensitivity sub-category, and an isolation zone comprising transmissions to the high-sensitivity sub-category.

A method for distributed resource allocation in base stations includes determining a desired local reuse zone based on a number of interference-insensitive clients; determining a maximum neighborhood reuse zone size based on transmissions to clients; allocating positions for a local reuse zone, transition zone, and isolation zone within a frame based on the desired local reuse zone and the maximum neighborhood reuse zone size; probing on a coarse time scale to determine whether network conditions have changed; and if network conditions have changed, probing and adapting on a fine time scale to adjust zone sizes according to the changed network conditions.

A transceiver includes a categorization module configured to categorize a plurality of clients into a first category that includes interference-insensitive clients and a second category that includes interference-sensitive clients and to sub-categorize the clients in the second category into a low-sensitivity sub-category and a high-sensitivity sub-category; an allocation module configured to determine a desired local reuse zone based on a number of interference-insensitive clients, to determine a common reuse zone size based on transmissions from neighboring base stations, to allocate positions for a local reuse zone, transition zone, and isolation zone within a frame based on the desired local reuse zone and the common reuse zone size, to probe on a coarse time scale to determine whether network conditions have changed and, if network conditions have changed, to probe and adapt on a fine time scale to adjust zone sizes according to the changed network conditions; and a transmitter configured to transmit frames to clients according to the determined local reuse zone, transition zone, and isolation zone.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary multicell installation and network according to the present principles.

FIG. 2 is a diagram of an exemplary transmission frame including a reuse zone, an isolation zone, and a transition zone, according to the present principles.

FIG. 3 is a block/flow diagram of a method for resource allocation according to the present principles.

FIG. 4 is a block/flow diagram of a method for client categorization according to the present principles.

FIG. 5 is a block/flow diagram of coarse- and fine-scale adaptations to changing network conditions according to the present principles.

FIG. 6 is a diagram of a femtocell base station according to the present principles.

### DETAILED DESCRIPTION OF PREFERRED EMBODIMENTS

The present principles provide resource management for orthogonal frequency division multiple access multicells in a distributed manner. The present principles identify the spectral needs of clients of respective femtocells and enable resource reuse and resource isolation for each femtocell depending on client needs. This is accomplished in a way that maintains WiMAX (Worldwide Interoperability for Microwave Access) standards compatibility, such that embodiments of the present principles may be deployed immediately with commercial OFDMA clients, including WiMAX and LTE (Long-Term Evolution) clients.

The present principles address OFDMA resource management using a two-step client categorization to divide clients into two primary classes, those that have throughput benefits from reusing the spectrum (class 1) and those that gain throughput benefits from interference mitigation through isolation of resources (class 2). In other words, whereas some clients can receive data even in the presence of interference (such as those close to the base station), others need isolated resources. Class 2 is further subdivided into a class which benefits significantly from resource isolation (class 2h) and a class which benefits only marginally from such isolation (class 2l). The present principles schedule clients from both categories in a single frame, which employs a three-zone frame structure, including a reuse zone, a transition zone, and an isolation zone. The reuse zone operates all sub-channels and schedules class 1 clients, while the isolation zone schedules class 2h clients only on an orthogonal subset of sub-channels. The transition zone is used for 2l clients on the same subset of sub-channel as the isolation zone.

Resources are allocated to femtocells based on the categories of their clients and the traffic load for each client category. The present principles provide for adaptation on both coarse and fine time scales, using a fast iterative mechanism that is completely distributed and allows for individual execution at each femtocell without any cooperation.

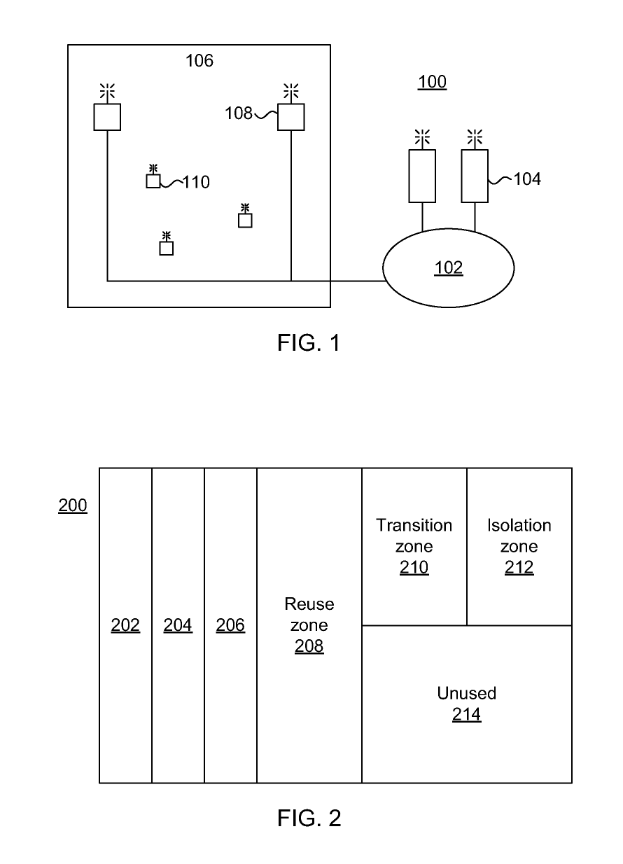

Referring now in detail to the figures in which like numerals represent the same or similar elements and initially to FIG. 1, an OFDMA network 100 according to the present principles is shown. While the present principles are described with particular attention to WiMAX implementations, it should be understood that they may be applied to any appropriate multicell OFDMA network. A number of macrocells 104 provide wireless access to a provider network 102, which may in turn be connected to the broader internet. An exemplary building 106 has poor reception from the macrocells 104, such that individual clients 110 have difficulty connecting to the provider network 102. In order to address this situation, femtocells 108 are installed on or within the building, providing access to the clients 110. Each femtocell 108 connects to the provider network 102 through some appropriate communication medium, e.g., a cable, DSL, or other broadband connection.

Building 106 may be particularly large, necessitating the installation of several femtocells 108. In such a case, neighboring femtocells may interfere with one another, degrading the performance and experience of clients 110. Toward this end, the femtocells 108 adjust their respective frame structure in accordance with the present principles.

Resource management techniques currently in use for macrocells 104 cannot be readily applied to femtocells 108. Unplanned deployment of femtocells 108 makes solutions designed for the well-planned macrocells 104 inapplicable. For example, fractional frequency reuse approaches are ineffective in mitigating the pervasive and unpredictable interference patterns in an installation of femtocells 108 in building 106. Solutions designed for WiFi are similarly unhelpful.

Referring now to FIG. 2, the structure of an exemplary femtocell frame 200 is shown. OFDMA networks use a combination of frequency division multiplexing and time division multiplexing. Differences along the vertical axis represent different OFDMA frequencies, each orthogonal frequency representing a sub-carrier, several sub-carriers being grouped into a sub-channel. How sub-carriers are grouped determines the channel diversity of a system. Distributed grouping picks sub-carriers for a sub-channel in a distributed manner, whereas contiguous grouping forms sub-channels from a contiguous set. The former provides uniform gain and interference across sub-channels, whereas the latter preserves channel diversity. In this manner, multiple clients can communicate simultaneously using their respective frequencies in their assigned sub-channels.

Differences along the horizontal axis represent different time slots, known as “symbols,” which allow for further sub-division of resources between clients. A combination of a symbol and a sub-channel is known as a “tile,” which is the basic unit of resource allocation. In multicell OFDMA systems, frames are synchronized both between the base stations 108 and the mobile stations 110, as well as across base stations 108. Frames are sent out in periodic intervals defined by the particular communication specification used (e.g., 5 ms in WiMAX, 1 ms in LTE).

In an exemplary frame, there is a preamble and control section 202, which allows a mobile station 110 to lock onto the cell 108 and provides scheduling information, a free zone 204, which is used to measure client throughput without interference, and an occupied zone 206, which is used to measure client throughput with interference from other femtocells 108. Free zones 204 and occupied zones 206 are measurement zones used in client categorization. All sub-channels and a small number s of symbols are assigned for both zones. The quantity s is a constant greater than or equal to two, and is considered to be set to two herein. Every base station 108 operates on all sub-channels in the occupied zone and schedules a client in this zone to calculate the ratio of delivered bursts to the total number of transmitted bursts. A random access mechanism is used to determine access to the free zone 204. Based on the measured burst delivery ratios (BDRs), the base station 108 categorizes clients 110 into classes as described below. The preamble 202 is generally transmitted with a higher power compared to the other parts of the frame 200.

The breakdown of the reuse zone 208 for class 1 clients 110, the transition zone 210 for class 2l clients 110, and the isolation zone 212 for class 2h clients 110 will be particular to each cell 108. Because the resource allocation of one cell impacts multiple other cells, adaptive mechanisms are used to quickly converge to a network-wide efficient solution. The reuse zone 208 operates across all sub-channels, while transition zone 210 and isolation zone 212 operate on only a subset of sub-channels.

Different cells 108 will have different sizes of reuse 208 and isolation zones 212 based on their client compositions, such that the size of the zone is proportional to the load generated by the clients of the corresponding class. If two interfering cells 108 were to operate independently, the larger reuse zone 208 would overlap with the isolation zone 212 of the other cell 108 and hence interfere with the isolation clients 110 of that cell 108. Consequently, it is important to use a common reuse zone 208 between interfering cells 108.

Because each cell 108 determines the common reuse zone on its own in a purely distributed system, the common reuse zone size can either be the minimum or maximum of the reuse zone sizes of its neighboring interfering cells 108. That is to say, the maximum of potentially interfering cells is used, rather than the maximum from the entire network. The present principles use the maximum of the reuse zone sizes in the interference neighborhood for the common zone for two reasons: (i) since the deployment is uncoordinated and non-cooperative (e.g., in residential complexes), there is no incentive for a cell to decrease its reuse zone size; and (ii) in the absence of sensing by the clients, active probing by the base station 108 to determine resource availability can only be effectively employed to determine the reuse zone of a cell with a larger zone size.

Previous resource management schemes have used a two-zone structure, but that approach is not sufficient in a multicell context. In the three-zone structure of the present principles, the isolation zone 212 begins at the end of the common maximum reuse zone 208 in the neighborhood. The region between a reuse zone 208 for a given cell 108 and the maximum common reuse zone is set as a transition zone 210. Blindly scheduling class 2 clients in the transition zone is harmful to performance due to interference from neighboring cells 108 with larger reuse zones 208. Leaving the transition zone 210 empty, however, will under-utilize resources. As such, those users in class 2l, which are less impacted by interference, are scheduled in the transition zone 210, whereas those in class 2h, most impacted by interference, are scheduled in the isolation zone 212.

This approach has several benefits. First, the transition zone 210 allows selected class 2 clients to opportunistically reuse resources without incurring significant interference. Second, operating the transition zone 210 on the same subset of sub-channels as the isolation zone 212 prevents the common reuse zone from propagating to the entire network, a condition which would be unfair to class 2h clients. Substantial throughput benefits result from proper sub-classification of class 2h and 2l clients.

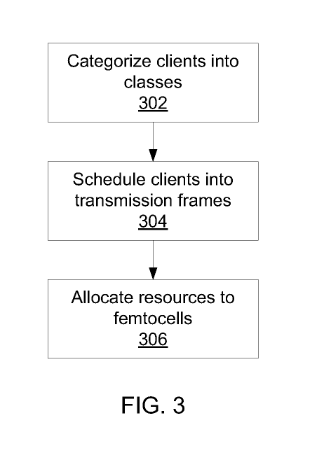

Referring now to FIG. 3, a method for OFDMA resource management is shown. Block 302 categorizes the clients 110 into one of the three above-discussed classes. Unlike in WiFi, interference avoidance in OFDMA comes at the cost of a reduced set of tiles per femtocell 108, which leads to under-utilization if not handled carefully. Specifically, not all clients need resource isolation—link adaptation may suffice to cope with interference for clients 110 that are in close proximity to the base station 108. Since sensing the medium is not an option for OFDMA femtocells 108, the present principles employ intelligent active probing to accurately categorize clients 110. Block 304 schedules clients 110 from all categories into a frame 200 having the above-discussed three-zone frame structure. Block 306 allocates resources to each femtocell 108 in a distributed fashion. Each femtocell 108 determines its zone sizes and parameters in a completely distributed manner, using iterative joint-time and frequency resource allocation. This allows the scheduling allocations to adapt to network dynamics quickly and efficiently.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

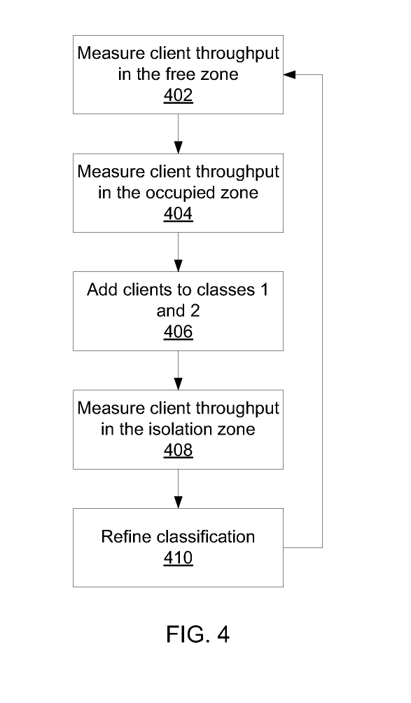

Referring now to FIG. 4, an exemplary method for client categorization is shown. The categorization of clients 110 is based on the throughput each client receives with and without interference—if throughput with interference is comparable to the throughput without, then the client 110 is in class 1, otherwise the client is in class 2. Base stations 108 do not have direct access to the throughput of the clients 110. However, the base stations 108 do receive feedback about the reception of each data burst via acknowledgement information on uplink frames. As noted above, the BDR can be used to characterize throughput for clients 110. Since the uplink frame and the feedback may itself be corrupted by adverse channel conditions, this is only an estimate of the actual BDR. With active probing using small amounts of data, a base station 108 can obtain accurate BDR estimates for each of its clients.

Toward this end, the free zone 204 and the occupied zone 206 are used for measurement. Block 402 measures client throughput in the free zone 204. To accomplish this, only one base station 108 may be transmitting in the free zone 204 at a time, allowing that base station 108 to measure the BDR at its clients 110 without interference. A random access mechanism with probability γ/n is used to decide access to the free zone 204, where n is the number of interfering base stations 108 and γ≦1 is a constant parameter. Note that clients 110 associate with base stations 108 at different instants and, hence, it is unlikely that all interfering base stations 108 will categorize their clients at the same time. Hence, γ is used to increase the access probability to the free zone 204.

Block 404 measures client throughput in the occupied zone 206. Every base station 108 operates on all sub-channels in the occupied zone 206, allowing base stations to calculate the BDR for clients 110 in the presence of interference from other cells. Block 402 and 404 schedule regular data bursts in the measurement zones 204 and 206 to calculate BDR, thereby keeping the process transparent to clients and retaining standards compatibility. A femtocell 108 may implement blocks 402 and 404 in any order, scheduling a client's data on the occupied zone 206 and free zone 204 probabilistically. The resulting BDR is stored in both of the zones over K frames. The BDRs are used to calculate corresponding throughputs in the two zones, T_{occ} and T_{free}. Block 406 categorizes clients 110 into class 1 and class 2. If T_{free}≦(1+α)T_{occ}, then the client 110 is categorized as class 2, otherwise it belongs to class 1. In one exemplary embodiment, the parameter α is set to 0.25. The parameter α is an empirically derived thresholding value used to differentiate between class 1 and class 2 clients. It may take values between 0 and 1. Generally, 0.25 is a reasonable value, but it is contemplated that other values may be used instead.

After initial classification in block 406, not all clients 110 that are categorized as class 2 will need full resource isolation. With resource isolation, a base station 108 allocates only a subset of resources to a client 110. For clients with low to moderate interference, link adaptation may be a better option for coping than sacrificing resources through isolation. Thus, to further refine the categorization of class 2 clients, block 408 factors in the loss of resources due to isolation. The amount of isolated resources available to a cell 108 depends on the resource allocation scheme used. If resource management assigns a fraction f of the total sub-channels to the isolation zone 212, block 408 refines the status of a client in class 2 by scheduling the client on resources in the isolation zone 212 and determines its throughput-per-resource Tᵢₛₒₗ in that zone. If f·Tᵢₛₒₗ≧(1+β)T_{acc}, then block 410 keeps the client 110 in class 2 and reverts the client 110 to class 1 otherwise. In this case, β is a constant parameter set to 0.05 that is used to avoid oscillations in categorization. Block 410 further refines the classification by splitting the class 2 clients into class 2h (those satisfying the condition

$$\frac{f \cdot {T}_{isol}}{{T}_{occ}} \geq ( 1 + α ) )$$

and class 2l (those satisfying the condition

$$( 1 + β ) \leq \frac{f \cdot {T}_{isol}}{{T}_{occ}} < ( 1 + α ) .$$

This process of categorization and refinement is iterative. With a set to 0.25, classification accuracy rises to over 90% in as few as 25 frames.

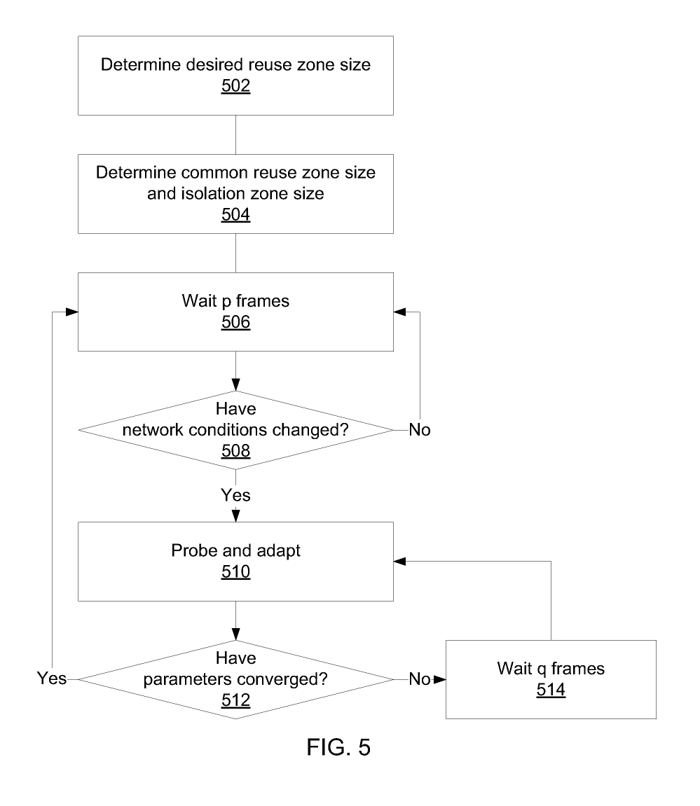

Referring now to FIG. 5, a method for resource allocation to the distributed cells 108 is shown. The goal of each cell 108 is to determine the size of the reuse (sᵣ) 208 and transition (sₜ) zones 210 as well as the specific set of sub-channels (C) for operation in the isolation zone 212. As noted above, each base station 108 classifies its clients 110 into classes 1, 2l and 2h in block 302. Each client in class 2h determines its set of strong interferers based on whether or not the received signal power is over a threshold, Sₜₕ. Using feedback from these clients 110, the base station 108 determines the super-set of strong interferers. The cardinality of this set (n) determines the fair share allocation of sub-channels

$$( m = \frac{N}{n} )$$

for the clients 110 in the isolation zone 212 (class 2h). Then, the BS determines the desired size of its reuse zone sᵣ 208 at block 502. This is proportional to the relative traffic from the clients 110 in the two classes and the load generated. Next the base station determines the common reuse zone 208 (in time, sₜ) in its interference neighborhood as well the specific set of m sub-channels (in frequency, C) for operation in the isolation zone 212 in block 504. After determining the resource allocation parameters, clients 110 in classes 1, 2l and 2h are scheduled in the reuse 208, transition 210 and isolation zones 212 respectively, see block 304 in FIG. 3.

The present principles employ a combination of coarse and fine time-scale adaptations as network conditions change. After initialization, each base station 108 has a period P of coarse adaptation on the order of seconds, for example comprising hundreds of frames. P is picked from a set of large prime numbers to reduce a frequency of overlap for adaptation and probing periods across cells 108. The goal of coarse adaptation is to track coarse network dynamics such as traffic load changes, (de)activation of clients, etc., that happen at the granularity of several seconds. Block 506 waits P frames before block 508 checks whether network conditions have changed. If network conditions remain unchanged, processing returns to block 506 to wait another P frames.

If network conditions have changed, fine scale adaptations are triggered in block 510. The goal of fine scale adaptations is to quickly converge to an accurate set of allocation parameters sₜ and C for a given set of network conditions. During fine adaptation, the base station 108 probes and adapts and determines in block 512 whether the parameters have converged to a new value. If not, block 514 waits q frames before returning to probe-and-adapt block 510. If parameters have converged, processing returns to coarse-scale adaptation by returning to block 506. The fine scale period q is randomly selected from a range of [1,0.1P] and operates at the granularity of, e.g., milliseconds.

Employing coarse adaptation in isolation would result in long recovery times in the event of probing collisions between femtocells 108. Such an event could lead to large periods of degraded performance. On the other hand, employing fine adaptation in isolation would require continuous probing to track network dynamics, thereby resulting in large overhead. The present principles strike a balance between coarse and fine adaptations; fine adaptation is suspended after quick convergence to an efficient resource allocation at block 512 and invoked again only after P frames if there is a change in network conditions at block 508. Thus, the base station 108 spends a large fraction of its P frames operating on an efficient allocation with its probing and adaptation mechanism making up only a small portion of the runtime.

To achieve the goal of quick convergence in both time and frequency domains in fine adaptation, joint time-frequency adaptation is used. In block 510, each base station 118 probes a vertical strip of resources in the frame 200 having a size Δt×N, encompassing all sub-channels in time Δt, where Δt is the granularity of probing in the time domain (on the order of a few symbols). The frequency domain is further probed in contiguous chunks of Δf sub-channels, with Δf=m·Δt and Δf may be varied to trade off fine-grained allocation and convergence time.

The following pseudo-code shows one exemplary implementation of the probe-and-adapt block 510.

| 1: | $m = \frac{N}{n} , {c}_{i} ∈ C , {s}_{t} ← {s}_{r} , {f}_{c} \text{:} current frame , b \text{:} BRD$ | | | | | |
|---|---|---|---|---|---|---|
| 2: | probing = true, found = noExpand = False | | | | | |
| 3: | while True do | | | | | |
| 4: | | if probing then | | | | |
| 5: | | | Probe c_{c}, update b_{c}, sₜ + = Δt | | | |
| 6: | | | for i = 1:m do | | | |
| 7: | | | | Probe cᵢ, update bᵢ | | |
| 8: | | | end for | | | |
| 9: | | | probing = False | | | |
| 10: | | else | | | | |
| 11: | | | bₘ = arg max_{i:c}^{ᵢ} ε C(bᵢ) | | | |
| 12: | | | if (!found) & ((bₘ > b_{c} · α)\|\|(b_{c} > β))then | | | |
| 13: | | | | Select c_{f}: call Algo.2 or 3 | | |
| 14: | | | | c_{c} ← c_{f}, Found sᵢ | | |
| 15: | | | | found = noExpand = probing = True | | |
| 16: | | | else | | | |
| 17: | | | | if !noExpand then | | |
| 18: | | | | | c_{c} ← cᵢ:i = arg max_{i:c}^{ᵢ} ε C(bᵢ) | |
| 19: | | | | | sₜ ← Δt, probing = True | |
| 20: | | | | else | | |
| 21: | | | | | Select c_{f}:call Algo.2 or 3 | |
| 22: | | | | | if c_{c} ≡ c_{f} then | |
| 23: | | | | | | c_{c} ← c_{c} ∪ ∃cᵢ ε C\{c_{f}}, s.t bᵢ > β |
| 24: | | | | | | found = False |
| 25: | | | | | | probing = True at f_{c} + P |
| 26: | | | | | else | |
| 27: | | | | | | c_{c} ← c_{f}, Pick q ε [1, 0.1P] |
| 28: | | | | | | probing = True at f_{c} + q |

| | |
|---|---|
| 29: | end if |

| | |
|---|---|
| 30: | end if |

| | |
|---|---|
| 31: | end if |

| | |
|---|---|
| 32: | end if |

| | |
|---|---|
| 33: | end while |

When block 510 is triggered, the base station 108 starts probing resource regions after its own reuse zone 208 to determine the common reuse zone 208 in its neighborhood (lines 4 and 5). The intuition is that, since the interfering cell 108 with the largest reuse zone 208 will use all sub-channels in its reuse zone 208, frequency chunks that are probed within the largest reuse zone will exhibit similar (degraded) BDRs, while when probed beyond the largest reuse zone 208, there will be at least one frequency chunk having a BDR that exceeds those of the other chunks by α. This observation is used by every base station 108 to determine the common reuse zone 208. Specifically, to probe in a vertical resource region, the base station 108 transmits data to a client 110 in each of the m frequency chunks (of size Δt×Δf); the chunks are chosen at random. Because P is varied across cells 108, and the frequency chunk to be probed is chosen at random, probing conflicts across resource regions are avoided. Each chunk is probed for, e.g., twenty-five frames and the BDR on each of these chunks is estimated (lines 6-7); the maximum BDR (across chunks) is determined and compared to the client's current recorded BDR (lines 11-12). The parameters of comparison are set as α=1.25, β=0.8. The β parameter is an empirically derived thresholding parameter to discriminate between 2l clients and 2h clients.

Two exemplary approaches to probing in the time domain are sequential and binary searching, though it is contemplated that any appropriate search may be used instead. In sequential probing (outlined in the above pseudo-code), the vertical strip to be probed is advanced sequentially by Δt until a gain exceeding α is seen compared to current BDR (time convergence) (lines 17-19). Otherwise, the current BDR is updated based on the maximum BDR with the recent probing. In binary search, two adjacent vertical strips are probed and the BDR in the left and right strips are compared. If BDR_{right}>BDR_{Ief}·α, then size of common reuse zone 208 has been detected (time convergence). The maximum BDR (across frequency chunks) is compared with the current BDR to determine the direction of adaptation and current BDR is updated only when the region probed is within the maximum reuse zone 208. If there are multiple clients in class 2h, they are probed together in each of the chunks and decisions are made with respect to each client. Since different clients may receive interference from different cells, the common reuse zone varies with respect to clients. Time domain probing continues until the common reuse zone 208 for each client 110 in class 2h is determined, with the largest common reuse zone 208 (among clients in class 2h) determining the termination of the transition zone 210 for the cell 108 (lines 12-15).

Once the common reuse zone 208 is detected, the base station 108 simultaneously has BDR information on m frequency chunks, with multiple frequency chunks potentially available for operation. Two exemplary approaches for selection of a frequency chunk include greedy and Gibbs samplers. While the greedy scheme is deterministic and picks the chunk yielding that has the highest BDR, the Gibbs sampler is probabilistic and favors chunks with higher BDR. Gibbs sampler has a temperature parameter T, which can be varied with time to provide an annealed version that converges to stable states of low potential (low interference and high BDR). While convergence in the time domain (common reuse zone 208) can be achieved with high accuracy, frequency domain convergence is sensitive to frequency selectivity and channel errors. Hence, the frequency chunk selected is confirmed by another iteration, which probes the frequency chunks alone (i.e. no increment of Δt) after q frames. If the same frequency chunk yields the highest BDR, then there is convergence in the frequency domain and the chosen time and frequency parameters are employed for operation till the next coarse adaptation (lines 21-25). Otherwise, probing in the frequency domain is repeated every q frames until contention (interference) is alleviated (lines 27-28), achieving convergence at block 512. Thus, by probing vertical strips of frequency chunks, the present principles determine both the common reuse zone 208 and the set of sub-channels (in the isolation zone 212) simultaneously, thereby leading to quick convergence.

Client (dis)-associations have an impact on the traffic load of a cell 108 and consequently on the resource allocations in the isolation zone 212. From an ideal (centralized) resource allocation standpoint, every cell 108 has to share the frequency resources in the isolation zone 212 of a frame in the contention domains that it belongs to (cliques in the interference/conflict graph), with its ideal share being determined by the size of the largest contention domain that it belongs to. When a new cell 108 is introduced or an existing cell 108 leaves (or traffic ceases) the contention domain, the existing share of frequency resources decreases or increases, respectively. However, this change is detected by each cell 108 in a completely distributed manner, thereby allowing cells 108 to contract and expand their sub-channel allocations in the isolation zone 212 in a distributed manner. Such a feature is also useful in improving the resource utilization in the network. Note that, since a cell 108 (A) does not have information on its contention domains (which would require global knowledge), it computes its fair share (say x, where x≦the ideal share) based on its interfering neighbors. However, if one of the neighboring cells 108 (B) belongs to a larger contention domain with a lower share (<x), then some resources (unused by B) will be under-utilized in cell As contention domain. The ability to probe and expand resource usage will avoid such under-utilization, a by-product of distributed operation.

The present principles provide for a cell 108 to adapt its sub-channel usage. Although a cell 108 selects one of the frequency chunks for operation upon convergence, it keeps track of the BDR in other frequency chunks and hence the potential set of chunks un-used by its neighboring cells 108. It continues to monitor such unused chunks for an additional period of P frames (coarse adaptation period), giving its neighbors enough time to detect and use their fair share. If some of these chunks still continue to be available, then the base station 108 expands its resource usage by adding (using greedy or Gibbs selection) one of the un-used chunks to its allocation (line 23). Adding one chunk at a time allows other cells 108 in the contention domain to also share the un-used resources in a fair manner. This expansion of resource usage will address cases when cells 108 switch off or cease to carry traffic. If, however, after expansion the ceased traffic in a cell 108 re-starts or a new cell enters the contention domain, this will be detected in the form of degraded BDRs on the frequency chunks or an additional interferer as sensed by its clients. In either case, the base station 108 will contract to its conservative share of sub-channels (in isolation zone 212) computed based on its set of interfering neighbors and re-run its probe-and-adapt process. Any resulting under-utilization in its contention domains will be addressed subsequently through its resource expansion mechanism.

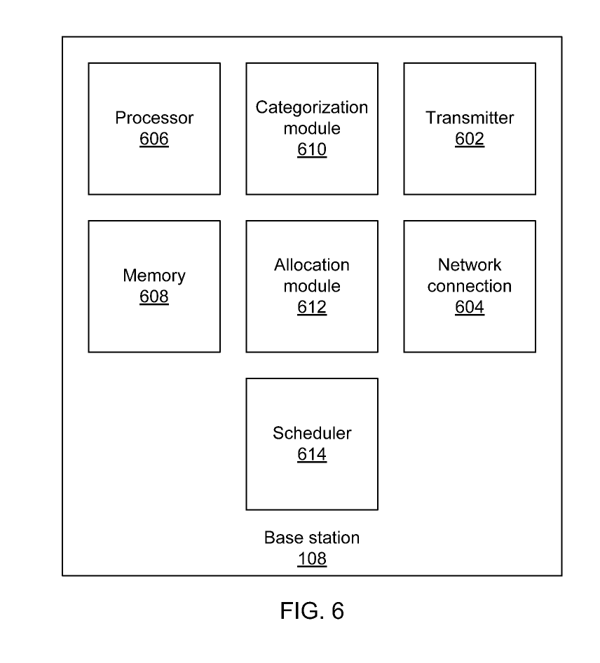

Referring now to FIG. 6, a detailed diagram of a base station 108 is shown. The base station 108 includes a transmitter 602 used to communicate with mobile clients 110 and a network connection 604 used to connect to a provider network 102. The network connection 604 may be any appropriate interface including, e.g., a cable modem, DSL, or a dedicated communication line. The base station 108 further includes a processor 606 and memory 608 which are in communication with categorization module 610, allocation module 612, and scheduler 614, to process and store client categorizations, base station resource allocations, and client schedules as described above. Said modules organize transmission frames 200 over the transmitter 602.

Having described preferred embodiments of a system and method for resource management in distributed OFDMA femtocell networks (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for scheduling, comprising:
categorizing a plurality of clients into a first category that includes interference-insensitive clients and a second category that includes interference-sensitive clients;
sub-categorizing the clients in the second category into a low-sensitivity sub-category and a high-sensitivity sub-category; and
transmitting frames to the plurality of clients that include a local reuse zone comprising transmissions to the first category, a transition zone comprising transmissions to the low-sensitivity sub-category, and an isolation zone comprising transmissions to the high-sensitivity sub-category.

2. The method of claim 1, wherein categorizing the plurality of clients is performed by characterizing clients' interference based on a measured burst delivery ratio.

3. The method of claim 1, further comprising determining a maximum reuse zone in a local neighborhood to use in setting the transition zone size.

4. The method of claim 3, further comprising setting the transition zone size as being a set of resources within the neighborhood maximum reuse zone not covered by the local reuse zone.

5. The method of claim 1, wherein the isolation zone comprises a subset of available frequency resources in the frames.

6. The method of claim 5, wherein the subset of frequencies used in the isolation zone is determined probabilistically or deterministically based on high burst delivery ratios.

7. The method of claim 1, wherein the local reuse zone and the transition zone operate on all frequency resources in the frames.

8. A method for distributed resource allocation in base stations comprising:
determining a desired local reuse zone based on a number of interference-insensitive clients;
determining a maximum neighborhood reuse zone size based on transmissions to clients;
allocating positions for a local reuse zone, transition zone, and isolation zone within a frame based on the desired local reuse zone and the maximum neighborhood reuse zone size;
probing on a coarse time scale to determine whether network conditions have changed; and
if network conditions have changed, probing and adapting on a fine time scale to adjust zone sizes according to the changed network conditions.

9. The method of claim 8, wherein allocating the transition zone includes determining a set of resources within the neighborhood maximum reuse zone not covered by the local reuse zone.

10. The method of claim 8, wherein allocating includes allocating the local reuse zone and the transition zone to all frequency resources in the frame.

11. The method of claim 8, wherein allocating includes allocating the isolation zone to a subset of the frequency resources in the frame.

12. The method of claim 11, wherein the subset of frequencies used in the isolation zone is determined probabilistically or deterministically based on high measured burst delivery ratios.

13. The method of claim 8, wherein probing and adapting on a fine time scale comprises:
joint probing in time and frequency to determine a new maximum neighborhood reuse zone; and
adjusting the transition zone to reflect the new maximum neighborhood reuse zone.

14. The method of claim 8, wherein determining the maximum neighborhood reuse zone comprises probing resource regions after the desired local reuse zone by transmitting to clients and determining a first resource at which a burst delivery ratio is undegraded or improved over an existing burst delivery ratio.

15. A transceiver, comprising:
a categorization module configured to categorize a plurality of clients into a first category that includes interference-insensitive clients and a second category that includes interference-sensitive clients and to sub-categorize the clients in the second category into a low-sensitivity sub-category and a high-sensitivity sub-category;
an allocation module configured to determine a desired local reuse zone based on a number of interference-insensitive clients, to determine a common reuse zone size based on transmissions from neighboring base stations, to allocate positions for a local reuse zone, transition zone, and isolation zone within a frame based on the desired local reuse zone and the common reuse zone size, to probe on a coarse time scale to determine whether network conditions have changed and, if network conditions have changed, to probe and adapt on a fine time scale to adjust zone sizes according to the changed network conditions; and
a transmitter configured to transmit frames to clients according to the determined local reuse zone, transition zone, and isolation zone.

16. The transceiver of claim 15, wherein the categorization module is further configured to categorize the plurality of clients is by characterizing clients' interference based on a measured burst delivery ratio.

17. The transceiver of claim 15, wherein the allocation module is further configured to set the transition zone size as being a set of resources within a neighborhood maximum reuse zone not covered by the local reuse zone.

18. The transceiver of claim 15, wherein the allocation module is further configured to allocate the isolation zone to a subset of available frequency resources in the frame and to allocate the local reuse zone and the transition zone to all frequency resources in the frame.

19. The transceiver of claim 18, wherein the allocation module is configured to select the subset of frequencies used in the isolation zone is determined probabilistically or deterministically based on high burst delivery ratios.

20. The transceiver of claim 15, wherein the allocation module is further configured to determine the common neighborhood reuse zone by probing resource regions after the desired local reuse zone by transmitting to clients and determining a first resource at which a burst delivery ratio is undegraded or improved over an existing burst delivery ratio.
